(19) United States
(12) Patent Application Publication
(10) Pub. No.: US 2013/0110755 A1
(43) Pub. Date: May 2, 2013

(54) SYSTEM AND METHOD FOR RENDERING DECISION SUPPORT INFORMATION TO MEDICAL WORKERS

(71) Applicant: WELLPOINT, INC., Chicago, IL (US)

(72) Inventors: Prakash Upadhyayula, Plainfield, IL (US); Aruna Guruprasad, Lodi, NJ (US); Sean J. Hickman, Glastonbury, CT (US); Ashok Chennuru, Powell, OH (US); Atul Apte, North Las Vegas, NV (US)

(73) Assignee: WELLPOINT, INC., Chicago, IL (US)

(21) Appl. No.: 13/660,566

(22) Filed: Oct. 25, 2012

Related U.S. Application Data
(60) Provisional application No. 61/553,507, filed on Oct. 31, 2011.
(60) Provisional application No. 61/553,144, filed on Oct. 28, 2011.

(51) Int. Cl. G06N 5/02

(52) U.S. Cl. CPC G06N 5/02
USPC 706/46

(57) ABSTRACT

Decision support information rendering systems and processes. A request for pre-authorization of a medical procedure for a medical condition is received. Data describing the request for pre-authorization is received. A recommendation regarding approval of the request for pre-authorization is received, the recommendation being generated by evidence based decision intelligence system.

### CROSS REFERENCE TO RELATED APPLICATIONS

This application claims priority to U.S. Provisional Patent Application Nos. 61/553,144, filed Oct. 28, 2011, and 61/553,507, filed Oct. 31, 2011, the entireties of which are incorporated herein by reference.

### FIELD OF THE INVENTION

The systems and methods described herein relate to decision support information rendering systems and processes.

### SUMMARY OF EMBODIMENTS OF THE INVENTION

The present invention is directed to systems, methods and computer-readable media for use in connection with providing decision support information to medical workers. A request for pre-authorization of a medical procedure for a medical condition is received. Data describing the request for pre-authorization is received. A recommendation regarding approval of the request for pre-authorization is received, the recommendation being generated by an evidence based decision intelligence system.

### BRIEF DESCRIPTION OF THE DRAWINGS

FIG. 1 is a diagram illustrating an example of the logical workspace of a decision support system of one embodiment of the present invention;

FIGS. 2A and 2B each depict a diagram illustrating an example the functionality that may be employed in connection with the decision support system of one embodiment of the present invention;

FIGS. 3A-3E are flow diagrams illustrating exemplary methods of the present invention;

FIGS. 4A-4N are exemplary user interfaces that may be used in connection with an exemplary embodiment of the present invention;

FIG. 5 is a diagram of an exemplary system that may be used to carry out the processes of an embodiment of the present invention; and

FIG. 6 is a diagram of an exemplary system illustrating exemplary computer hardware and software components that may be used in connection with an embodiment of the present invention.

### DETAILED DESCRIPTION

The decision support information rendering systems described herein provide an information rendering process that facilitates making evidence-based decisions. In one embodiment, the information rendering process is integrated with machine learning to facilitate efficient decisioning through automated decision recommendation display, and also allows for tracking user behavior during the process. Certain embodiments of the information rendering process also quantify behavior of decision makers through definition of specific behavior tracking metrics, decision trend measurements, and instrumentation for calibrating measurements.

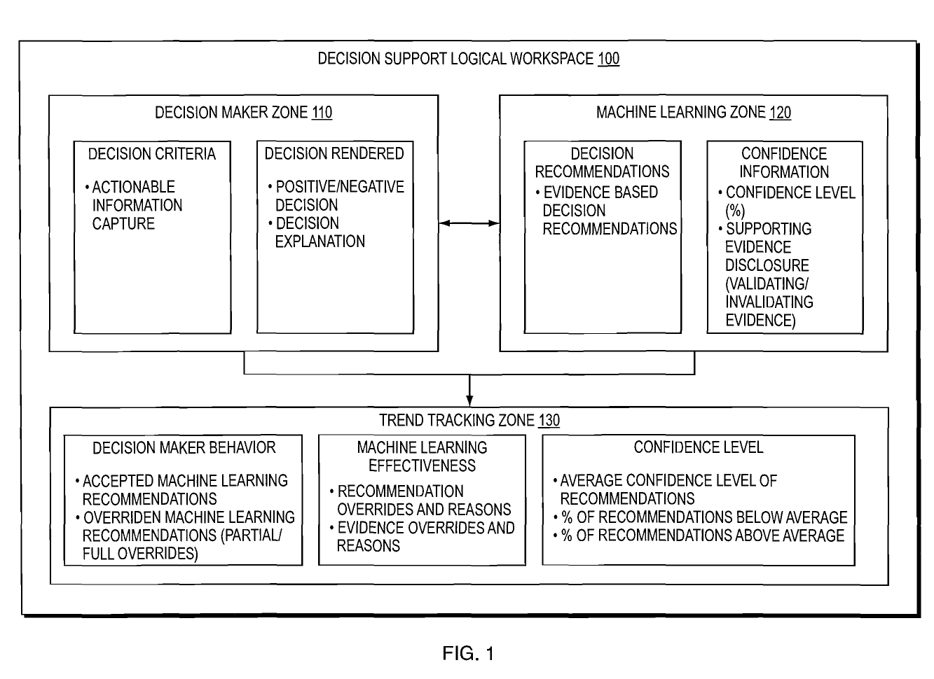

In one embodiment, the decision support information rendering system defines a workspace designed specifically for decision makers. The workspace 100 is composed of three logical zones, in an exemplary embodiment. FIG. 1 illustrates the logical decomposition of the workspace and the relationships between the components. The decision maker zone 110 is designed to capture actionable information through human-machine interactions or automated data capture. This zone 110 also captures the decision rendered by decision makers and the explanation for rendered decisions. The machine learning zone 120 is designed to capture decision recommendations from machine learning components as well as associated supporting evidence and the confidence level of the recommendation. The trend tracking zone 130 is designed to detect and track decision support trends including behavior of decision makers in terms of accepting or overriding machine learning recommendations, the effectiveness of machine learning recommendations and effectiveness of supporting evidence as well as the overall trend of confidence level in recommendations and rendered decisions.

Systematic and user friendly rendering of information in a decision support system can be a complex problem. The human-computer interaction models for decision support systems involve multiple categories of information that need to be rendered in a structure that facilitates a decision maker to make right decision at the right time. This implies that information needs to be structured for quick actions that lead or guide a decision maker towards the right decision path.

By defining a logical workspace specifically for decision support, the decision support information rendering system is able to compartmentalize information into actionable events. For example, a decision maker zone 110 renders information specifically necessary for a particular type of decision. Approval of a pre-authorization or approval of a treatment regiment is a specific decision type, by way of example. However, the system is equally applicable to other decision types. Decision maker zones 110 can be designed to align with one or more types of decisions. The machine learning zone 120 maintains a logical separation from decision makers, which clarifies and supports the notion that the primary responsibility for decisions lies with decision makers. Machine learning is responsible only for recommending the right decision at the right time based on the type of decision to be rendered. The trend tracking zone 130 monitors the decision makers' behavior and the effectiveness of machine learning throughout the decision making process. Separating the trend tracking zone 130 from other zones in the workspace creates the flexibility to make trend data visible or invisible depending on the type of decisions. In some instances, the trend tracking zone 130 could be entirely invisible or, in other situations, every measurement and data point on the trend curve can be visible. The overall structuring of the logical workspace can be implemented natively on different system platforms.

One embodiment of the decision support information rendering system includes the following characteristics of the decision support logical workspace: (1) disclosure of supporting evidence to decision recommendations; (2) historical decisions and associated reasons for specific decision types and decision criteria; (3) overriding behavior of decision makers; and (4) opportunity to improve evidence based on decision trends and decision maker behaviors. Disclosure of evidence supporting decision recommendations creates greater transparency into decision recommendations. These recommendations could come from machine learning sources or other experience, predictive and simulation sources. Regardless of the recommendation source, the disclosure of supporting evidence enables decision makers to quickly accept or override specific decision recommendations. Access to historical decisions and any associated reasons (e.g., in the form of decision maker notes) allows decision makers to quickly adopt decision trends. This is an important characteristic from an exceptional scenario perspective. For example, when a decision maker encounters an exceptional decision criterion, historical decisions and decision trends help decision makers maintain consistency of decisions rendered. Despite the advances in machine learning, decision recommendations are not 100% accurate yet. There is some level of uncertainty within each decision recommendation. This uncertainty is reflected in the confidence level associated with decision recommendations. By allowing decision makers to override decision recommendations and tracking the different decision maker's behavior relative to specific decision types, the decision support information rendering system creates opportunities to improve future machine learning recommendations. If decision maker behaviors are in conflict with decision trends, then appropriate corrective measures can be made to improve the decision recommendations. Improving supporting evidence based on decision trends and decision maker behaviors creates a feedback mechanism for the decision support information rendering system. The percentage of supporting evidence that needs changes or improvements will drive higher levels of effectiveness in utilizing machine learning.

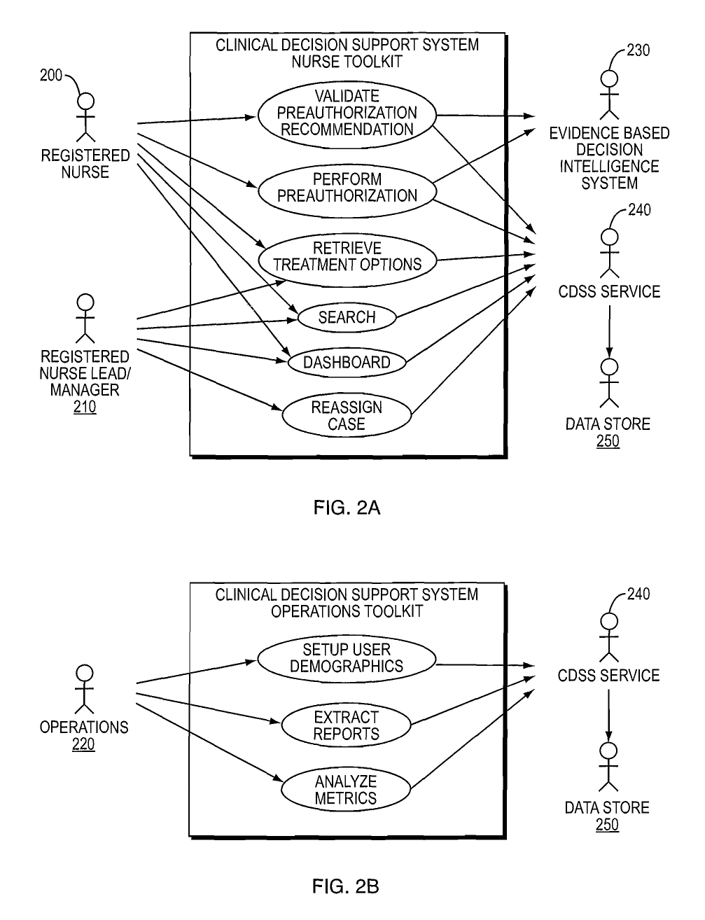

By way of example of how the decision support information rendering system can be used, reference is made to FIGS. 2A and 2B. FIGS. 2A and 2B illustrate features of the Clinical Decision Support System (CDSS) and its information rendition functions involving the primary actors (e.g. Clinical Staff, Operations etc), the decision support system and machine learning components, packaged in logical groupings. The examples described herein refer to the “Nurse Toolkit” for purposes of illustration only. The invention is not so limited. In particular, the inventive concepts can be used more broadly in connection with utilization management assistance, e.g., assisting medical workers, such as nurses, in making preauthorization recommendations on behalf of a healthcare payor and physicians assisting in preauthorization decisions on behalf of a healthcare payor. With reference to FIG. 2A, a medical worker 200, e.g., an RN or a physician acting on behalf of a healthcare payor, may perform activities including validating pre-authorization recommendations, and performing pre-authorization (in connection with an evidence based decision intelligence system 230 and the CDSS 240), as well as retrieve treatment options, perform searches, and access a dashboard (in connection with the CDDS 240), in connection with data store 250. A managerial knowledge worker 220 may perforin activities including retrieving treatment options, searching, accessing a dashboard, and reassigning cases (in connection with the CDDS 240). With reference to FIG. 2B, operations personnel may employ the CDDS 240 to set up user demographics, extract reports and analyze metrics, in connection with data store 250.

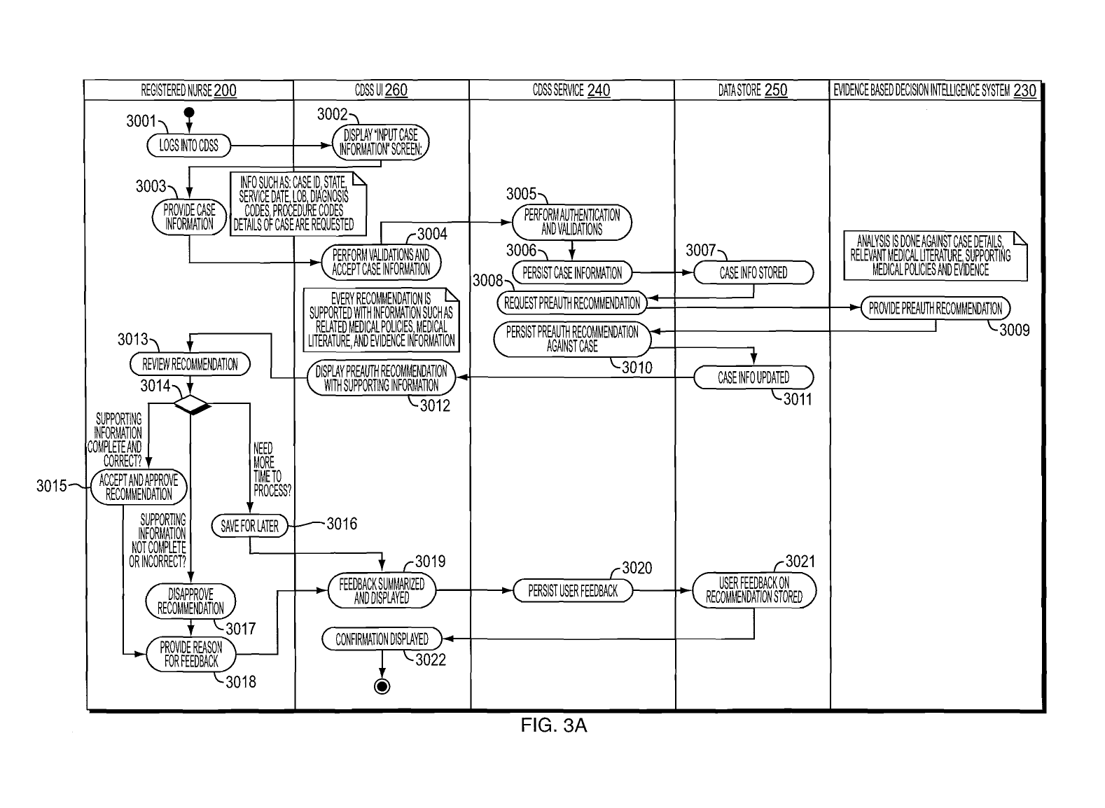

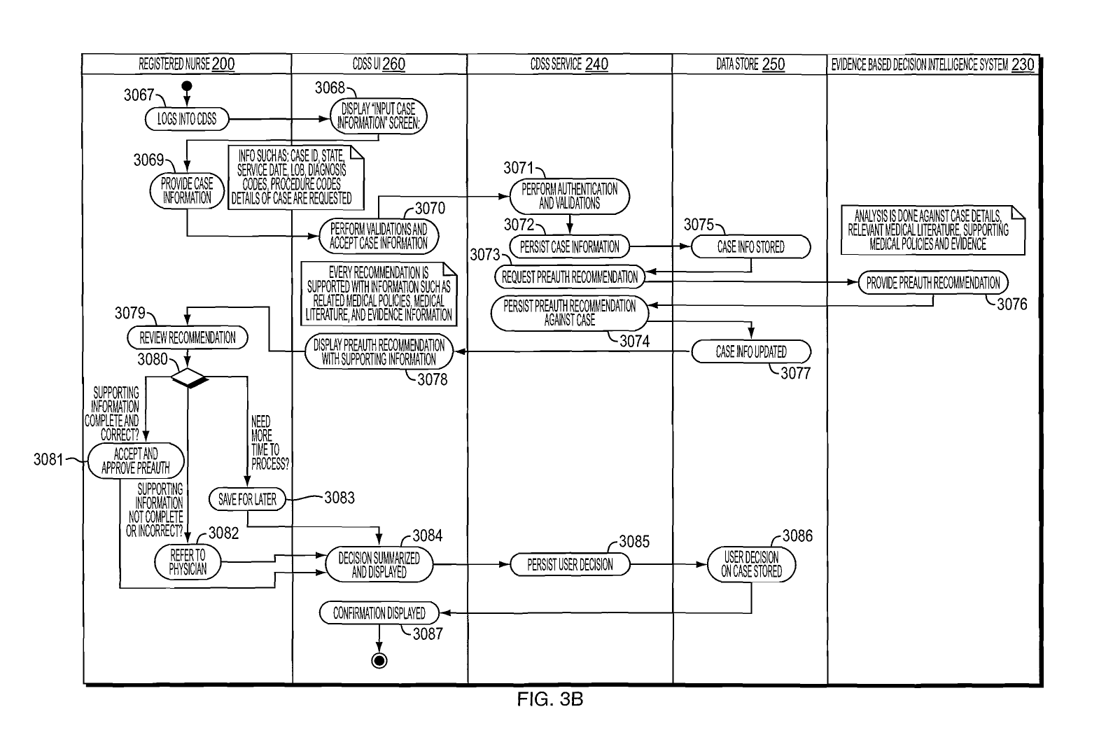

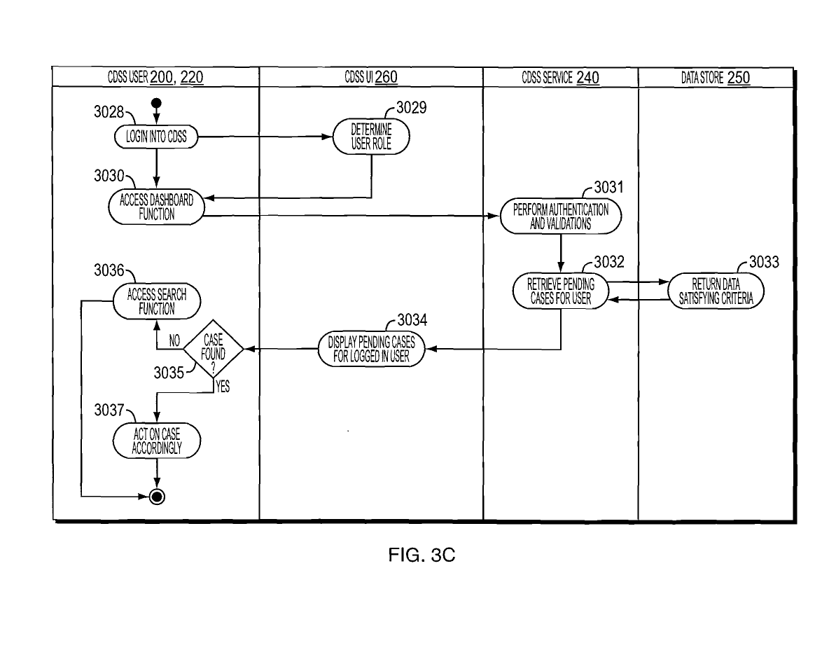

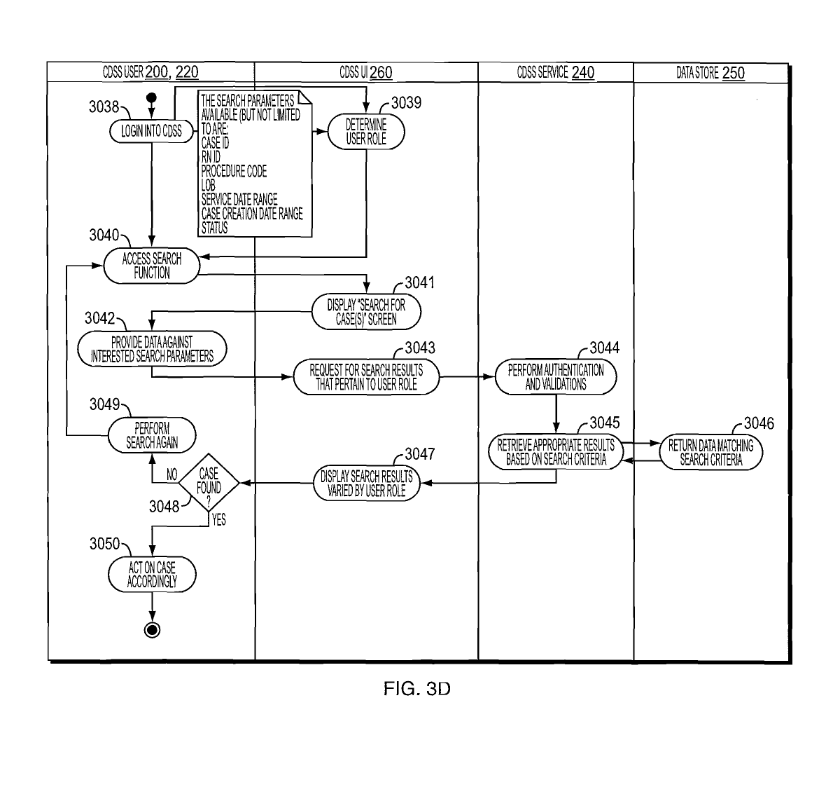

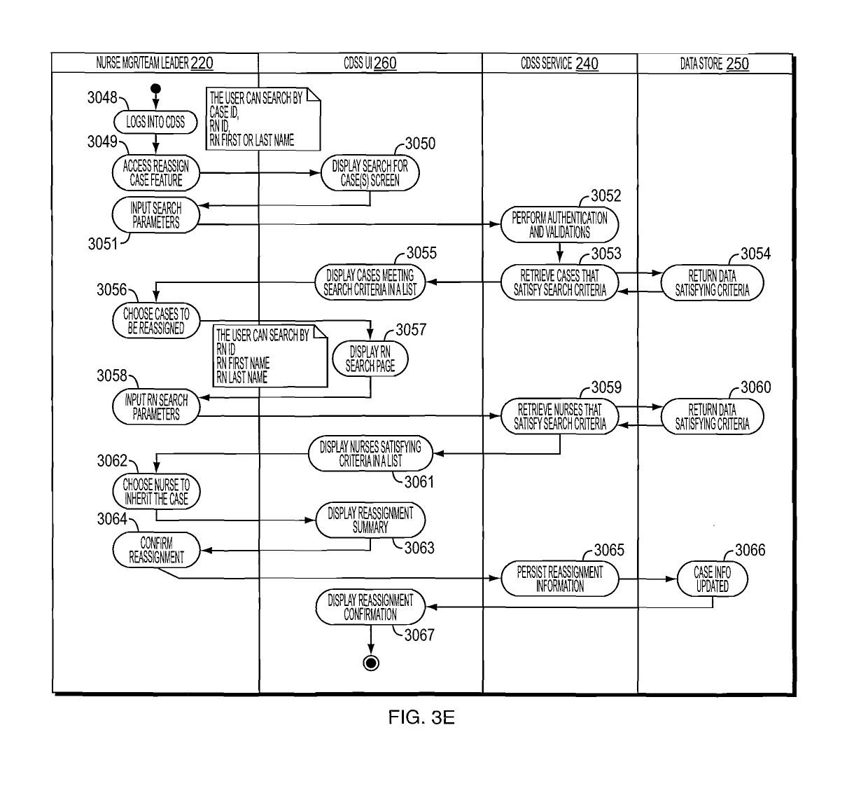

FIG. 3A is a flow chart illustrating an exemplary workflow for the “Validate PreAuthorization Recommendation” feature, in one embodiment. In connection with this feature, the medial worker 200 provides details pertaining to a case and requests preauthorization recommendations from the system, can view all the recommendations against each procedure requested, can provide feedback around acceptance or rejection of the recommendation, can provide appropriate justification and comments, and can save for completion at a later time. The CDSS user interface 260 captures all case information provided by the medical worker 200, validates the information, allows the medical worker 200 to correct invalid information, displays the preauthorization recommendations against each procedure in a clear and easy to understand manner, along with supporting evidence, referenced policies and guidelines, and details around missing evidence, displays a confidence factor against each recommendation, captures the feedback of the medical worker 200 on the recommendation and displays confirmation of feedback capture. The CDSS service 240 authenticates the request, validates the information received, handles persistence of the request and response from the evidence based decision intelligence system 230, and provides the decision suggestions to the CDSS user interface 260. The data store(s) 250 captures and stores all information received and displayed to the medical worker 200 and his/her feedback on the recommendations. The evidence based intelligence system 230 analyzes the requested case information against medical literature, publications, policies and journals to determine all recommendations with varying confidence levels.

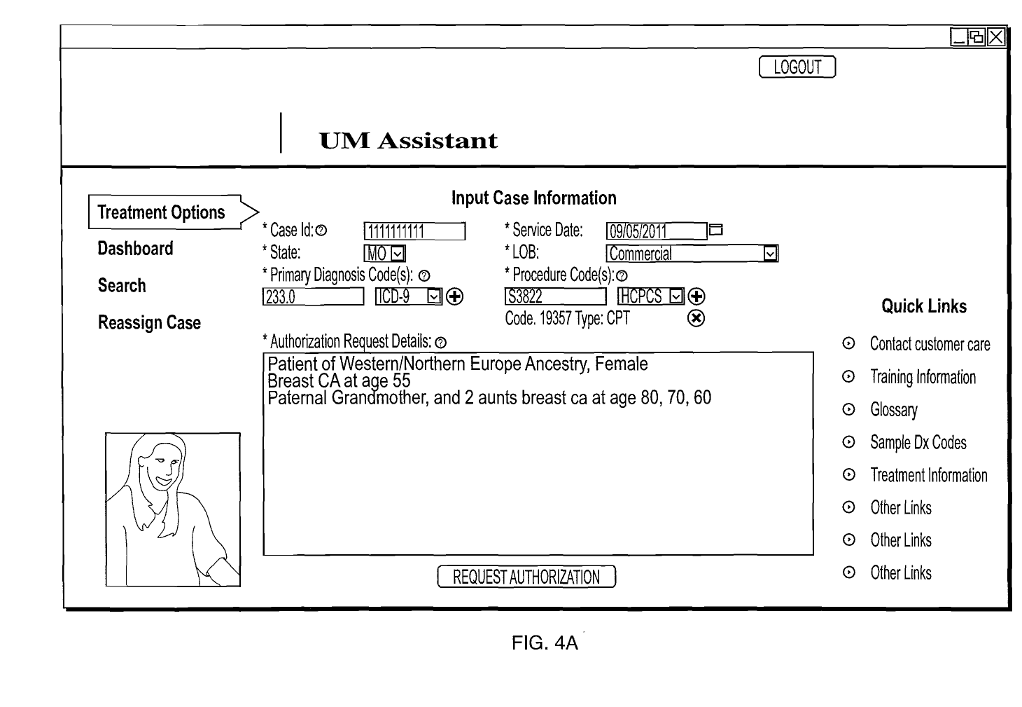

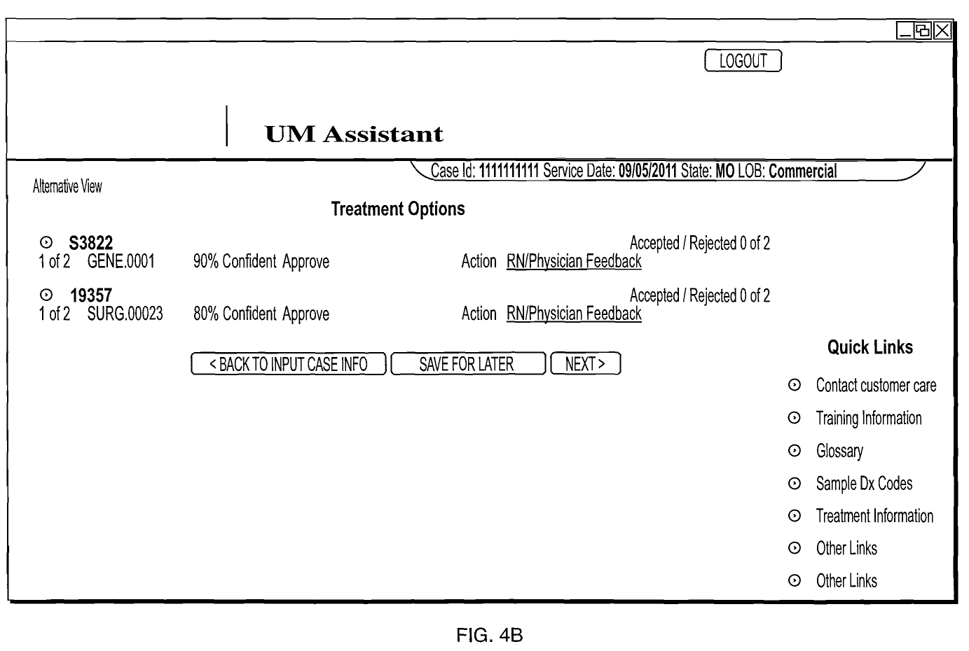

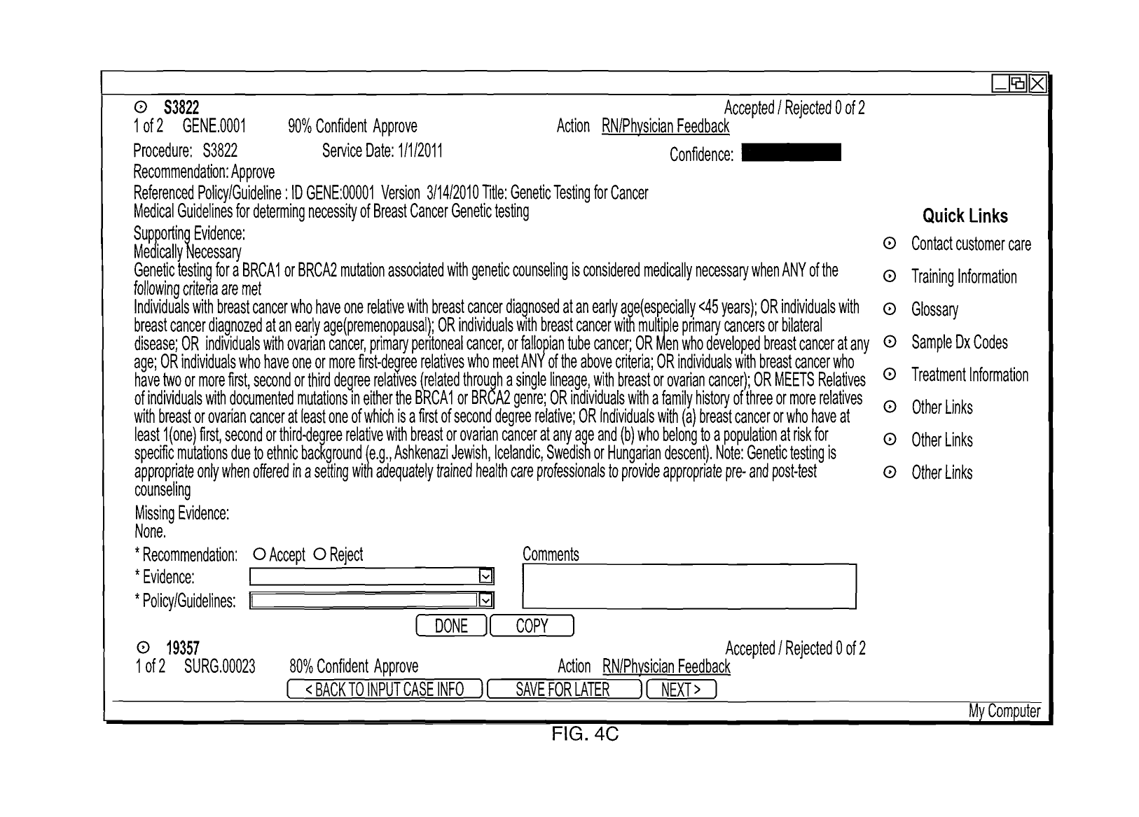

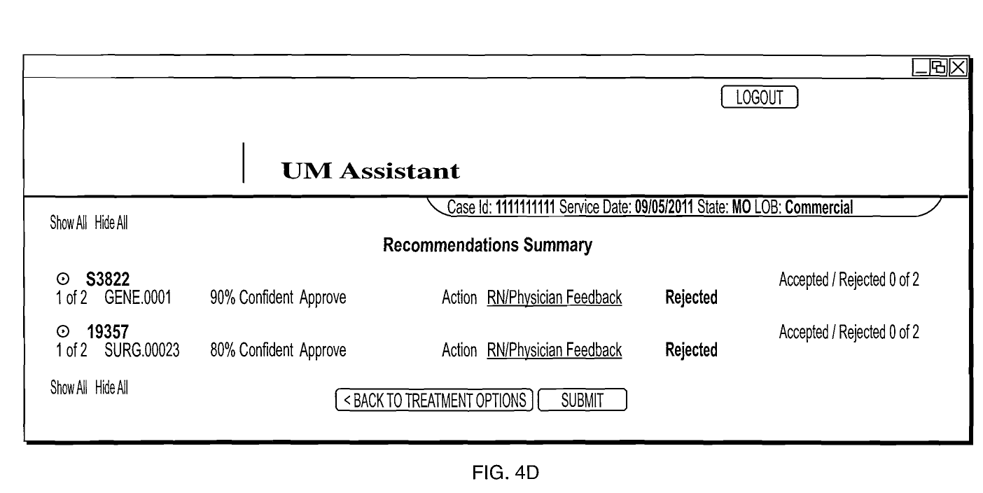

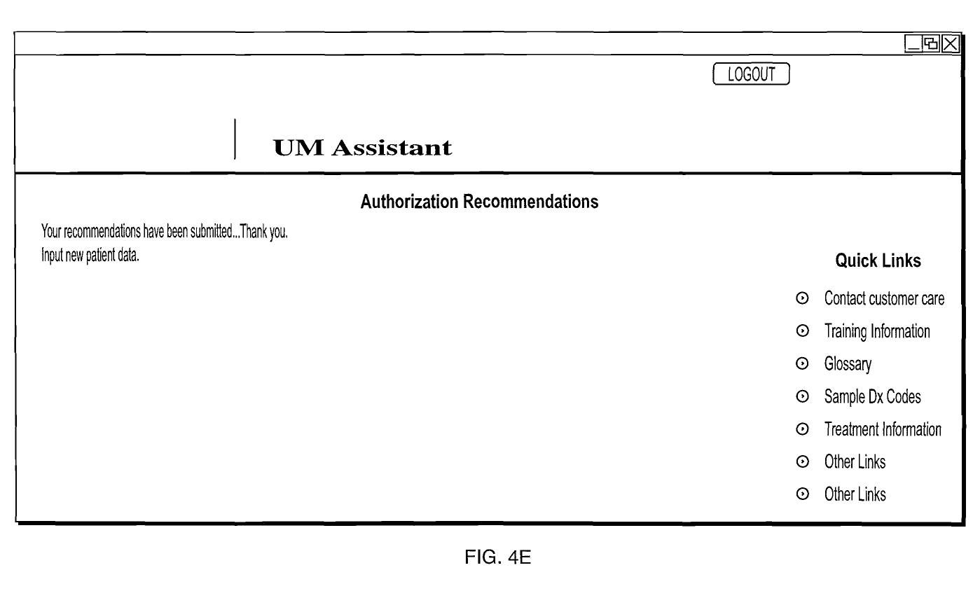

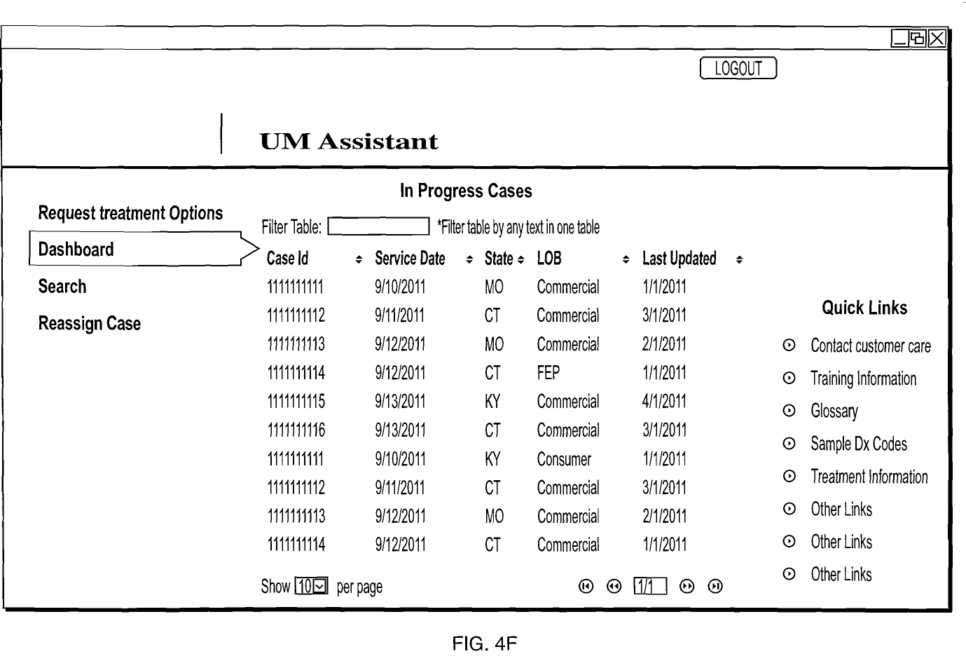

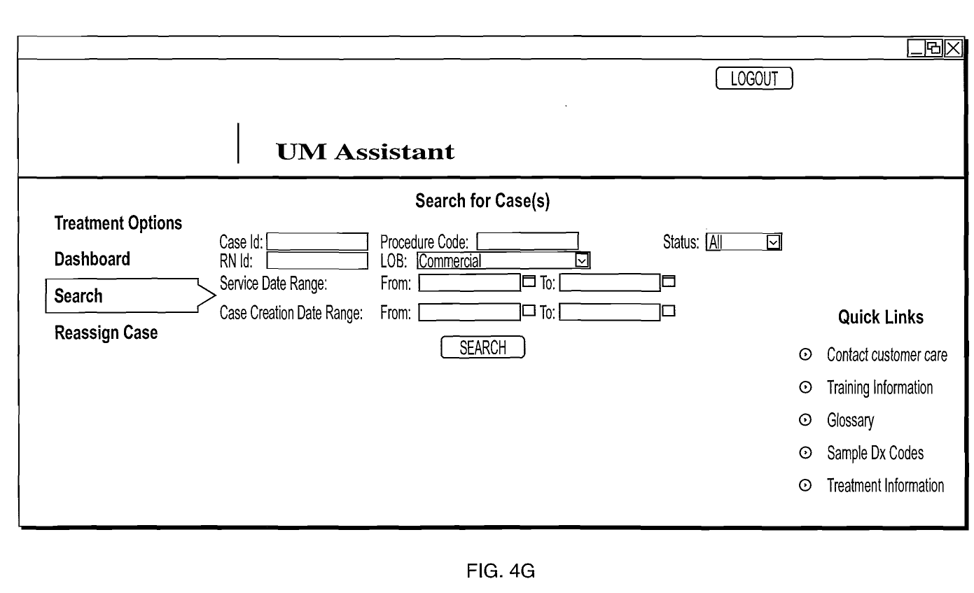

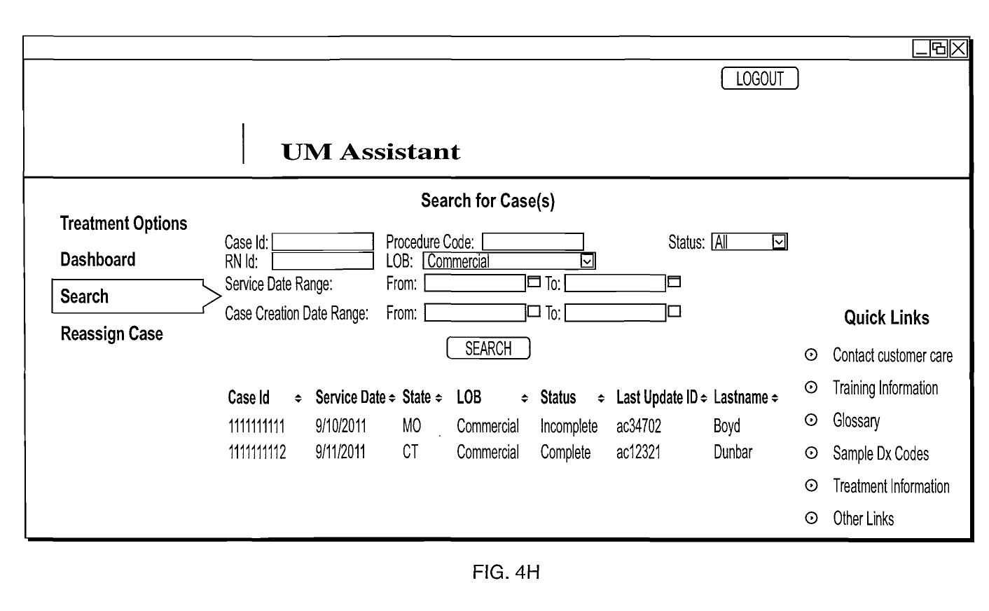

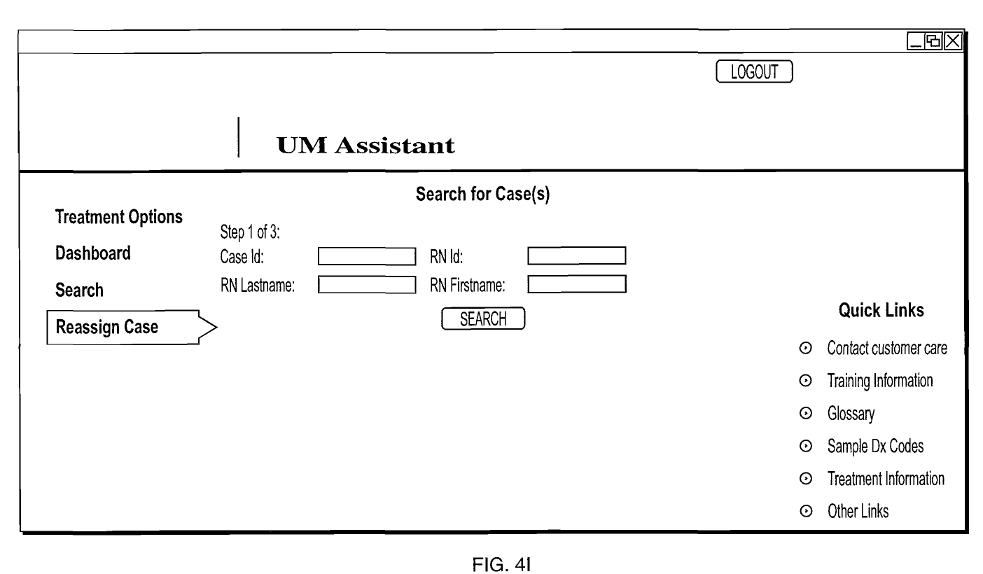

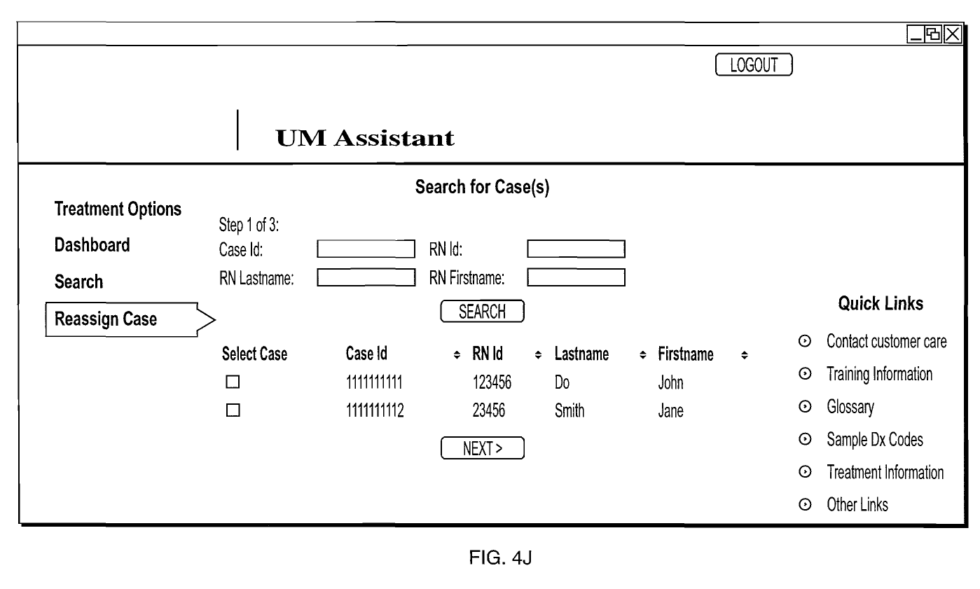

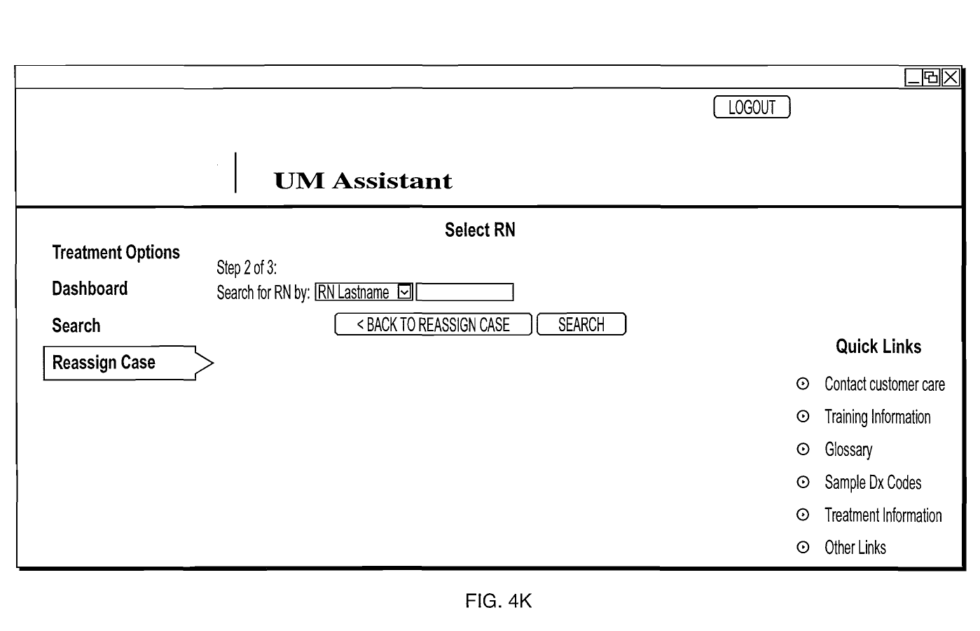

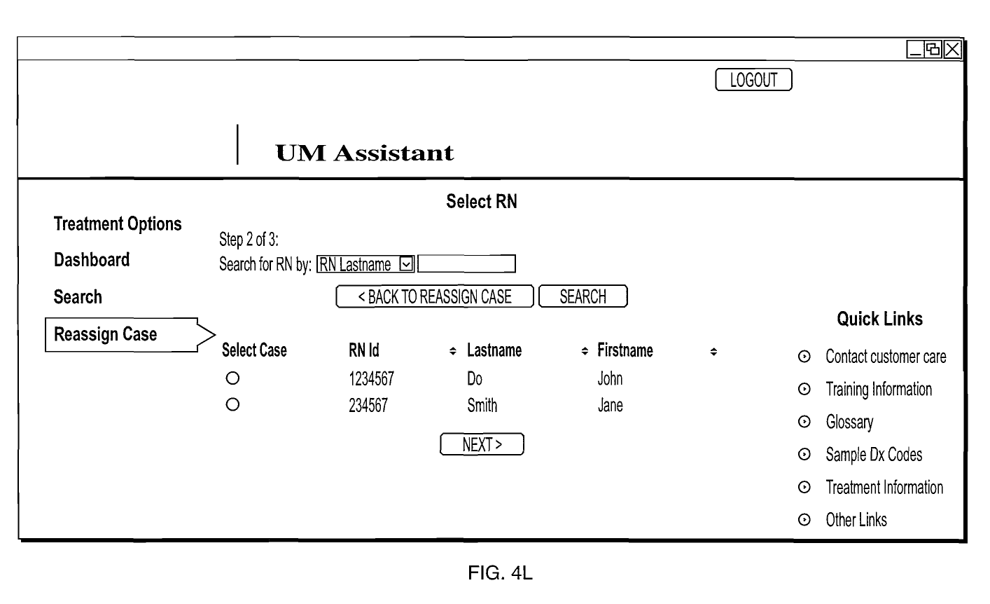

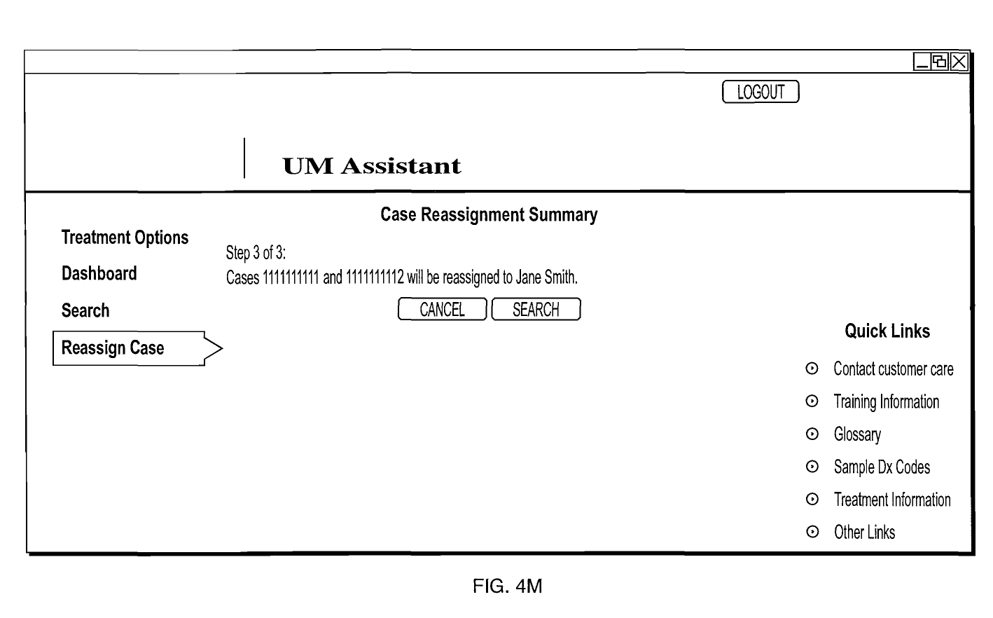

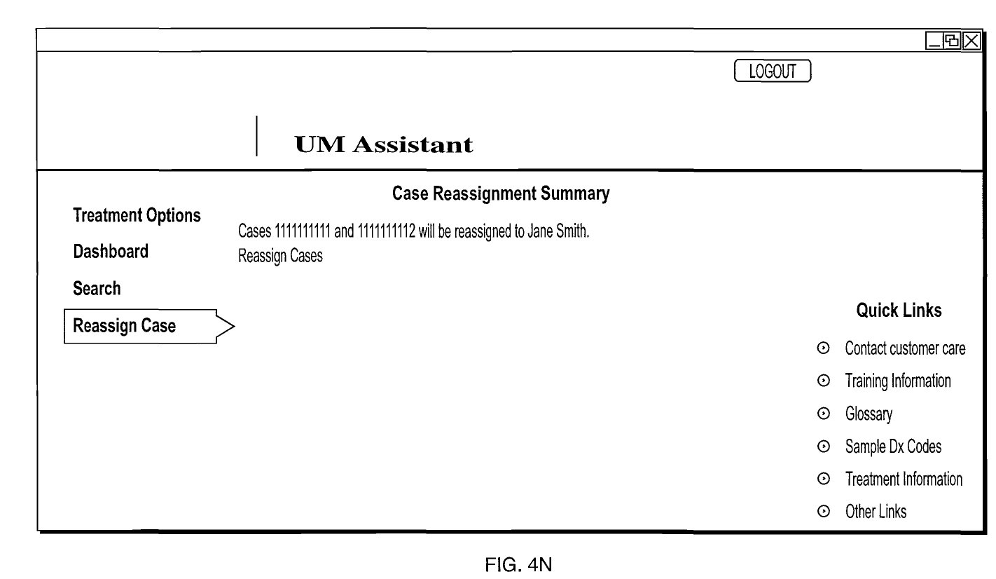

Referring now specifically to FIG. 3A, in step 3001, the medical worker 200 logs into the system using CDSS interface 260. A screen is displayed, in step 3002, that allows for case information to be inputted. FIG. 4A show an exemplary screen. In step 3003, the medical worker 200 inputs case information. In step 3004, the validation is performed on the case information, which is then accepted. In step 3005, the CDSS service 240 performs authentication of the medical worker and validates the case information. In step 3006, the case information is persisted and, in step 3007, stored in data store 250. In step 3008, the CDSS Service 240 makes a request for a preauthorization recommendation. In step 3009, evidence based decision intelligence system 230 analyzes the case details, relevant medical literature and supporting medical policies and evidence and provides a preauthorization recommendation. In step 3010, the preauthorization recommendation is persisted against the case and, in step 3011, the case information is updated in the data store 250. In step 3012, the preauthorization recommendation is displayed, along with supporting information, on the CDSS UI 260. FIG. 4B illustrates an exemplary interface in this regard. In step 3013, the medical worker 200 reviews the recommendation and, in step 3014, determines whether the supporting information is complete and correct. FIG. 4C illustrates an exemplary interface that presents the referenced policies/guidelines and supporting evidence to the medical worker. If the supporting information is complete and correct, the medical worker 200 may validate the recommendation in step 3015. If not, the medical worker 200 can indicate that the recommendation cannot be validated in step 3017. If the medical worker 200 needs more time to process, in step 3016, the decision can be saved for later. In the case of validation or invalidation, the medical worker 200 can provide a reason and feedback, in step 3018. In step 3019, the feedback is summarized and displayed. In step 3020, the user feedback is persisted by the CDSS Service 240 and stored in data store 250, in step 3021. In step 3022, confirmation of the action of the medical worker is displayed by the CDSS UI 260. FIG. 4D illustrates an exemplary interface that shows the confirmation of the medical worker's action. With reference to FIG. 4E, once the medical worker submits his recommendation, a confirmation screen may be displayed.

FIG. 3B is a flow chart illustrating an exemplary workflow for the “Perform Case PreAuthorization”, in one embodiment. The medical worker 200 (e.g., RN) provides details pertaining to a case and request for preauthorization recommendations from the system, can view all the recommendations against each procedure requested, can accept and approve the preauthorization request for the case based on a complete recommendation, can refer to a physician based on incomplete or incorrect recommendation, and can save for completion at a later time. The CDSS user interface 260 captures case information provided by the medical worker 200, validates the information, allows the medical worker 200 to correct invalid information, displays the preauthorization recommendations against each procedure in a clear and easy to understand manner, along with supporting evidence, referenced policies and guidelines, and details around missing evidence, displays a confidence factor against each recommendation, captures medical worker action on recommendation and displays confirmation of action capture. The CDSS Service 240 Authenticates the request, validates the information received, handles storing the request in data store 250 and the response from the decision intelligence system 230, and provides the decision suggestions over to the CDSS UI 260. Data store 250 captures and stores all information received and displayed to the medical worker and their feedback on the recommendations. The evidence based intelligence system 230 analyzes the requested case information against medical literature, publications, policies and journals to determine all recommendations with varying confidence levels.

Referring now specifically to FIG. 3B, in step 3067, the medical worker 200 logs into the system using CDSS interface 260. A screen in displayed, in step 3068, that allows for case information to be inputted. In step 3069, the medical worker 200 inputs case information. In step 3070, the validation is performed on the case information, which is then accepted. In step 3071, the CDSS service 240 performs authentication of the medical worker and validates the case information. In step 3072, the case information is persisted and, in step 3075, stored in data store 250. In step 3073, the CDSS Service 240 makes a request for a preauthorization recommendation. In step 3076, evidence based decision intelligence system 230 analyzes the case details, relevant medical literature and supporting medical policies and evidence and provides a preauthorization recommendation. In step 3074, the preauthorization recommendation is persisted against the case and, in step 3077, the case information is updated in the data store 250. In step 3078, the preauthorization recommendation is displayed, along with supporting information, on the CDSS UI 260. In step 3079, the medical worker 200 reviews the recommendation and, in step 3080, determines whether the supporting information is complete and correct. If so, the medical worker 200 may accept and approve the recommendation in step 3081. If not, the medical worker 200 may refer the recommendation to a physician, acting on behalf of the healthcare payor, in step 3082. If the medical worker 200 needs more time to process the information, in step 3083, the decision can be saved for later. In step 3084, a decision is summarized and displayed. In step 3085, the user decision is persisted by the CDSS Service 240 and stored in data store 250, in step 3086. In step 3087, confirmation of the action of the medical worker is displayed by the CDSS UI 260.

FIG. 3C illustrates an exemplary workflow of the “Dashboard” feature that may be available as part of the CDDS, in one embodiment. The CDSS UI 260 determines the user 200/220 and displays in a simple, easy to comprehend list, all the pending cases that were saved by the user 200/220 at an earlier point in time, and allows the user to select and act further on any such displayed cases. The CDSS Service 240 authenticates the request, validates the information received, and handles retrieving the pending cases from the data store. The data store 250 provides the ability to retrieve all of the pending cases that were previously saved or no action was taken by the user.

Referring now to the specific steps illustrated in FIG. 3C, in step 3028, the user 200/220 logs into CDSS. In step 3029, the CDSS UI 260 determines the role of the user 200/220. Depending on the user role, in step 3030, the user accesses various dashboard functions. In step 3031, the CDSS Service 240 performs authentication and validation. In step 3032, the CDSS Service 240 retrieves pending cases for the user. Data store 250 returns the data satisfying the criteria in step 3033. In step 3034, the CDSS UI 260 displays the pending cases for the logged in user. In step 3035, it is determined whether the case of interest is found. If yes, in step 3037, the user 200/220 can act on it accordingly. If not found, in step 3036, the user 200/220 can access the search function and, in step 3037, act on the case accordingly. An exemplary dashboard is illustrated in FIG. 4F.

FIG. 3D illustrates an exemplary workflow of the “Search” feature that may be available as part of the CDSS, in one embodiment. The CDSS UI 260 determines the user 200/220 and displays in a simple, easy to comprehend list, all the cases that satisfy the search criteria provided by the user, allows the user to select and act on pending cases and review completed cases. The CDSS Service 240 authenticates the request, validates the information received, and handles retrieving the cases satisfying the search criteria from the data store. The data store 250 provides the ability to retrieve a list of all the cases satisfying the search criteria. The user 200/220 can perform analysis on related cases and understand trends form previous cases for better decision making process on current and new cases.

Referring now to the specific steps illustrated in FIG. 3D, in step 3038, the user 200/220 logs into the CDSS. In step 3039, the user's role is determined by the CDSS UI 260. In step 3040, the user 200/220 may access the search function. In step 3041, the Search for Case screen may be displayed. In step 3042, the user 200/220 provides data for search parameters of interest. FIG. 4G provides an example of an interface that may be used for inputting search criteria. In step 3043, CDSS UI 260 makes a request for search results that pertain to the user role. In step 3044, the CDSS service 240 performs authentication and validation. In step 3045, CDSS service 240 retrieves the appropriate results based on the search criteria. In step 3046, data store 250 returns data matching the search criteria. In step 3047, the CDSS UI 260 displays the search results, varied by the role of the user 3047. FIG. 4H provides an example of an interface that may be used to display search results. In step 3048, the user 200/220 determines if the case of interest has been identified. If not, in step 3049, the search is performed again, returning to step 3040. If so, in step 3050, the user 200/220 may act on the case accordingly.

FIG. 3E, illustrates an exemplary workflow of the “Reassign Case” feature that is available as part of the CDSS, in one embodiment. The CDSS UI 260 determines the user and displays in a simple, easy to comprehend list, all the cases that satisfy the search criteria provided by the user, allows the user to select cases to be reassigned, displays search criteria and results satisfying the criteria, allows the user to select the worker to inherit the case, and displays confirmation of the reassignment. The CDSS Service 240 authenticates the request, validates the information received, retrieves the list of cases satisfying the search criteria from the data store, retrieves the medical workers that satisfy the search criteria, and persists case reassignment. The data store 250 provides the ability to retrieve all the cases satisfying the search criteria for cases, nurses and stores the case reassignment information.

The steps of FIG. 3E are now described. In step 3048, the user 200/220 logs into the CDSS and access the reassign case feature in step 3049. In step 3050, the search for case screen is displayed. FIG. 4I provides an exemplary screen that can be used in this regard. In step 3051, the user 200/220 may input search parameters. In step 3052, CDSS Service 240 performs authentication and validation and, in step 3053, retrieves cases that satisfy the search criteria. In step 3054, data store 250 returns data satisfying the criteria to CDSS service 240. In step 3055, CDSS UI displays cases meeting the search criteria in a list. FIG. 4J provides an exemplary interface displaying the cases meeting the search criteria. In step 3056, user 200/220 chooses the case(s) to be reassigned. In step 3057, CDSS UI 260 displays the medical worker search page. In step 3058, the user 200/220 can input medical worker search parameters. FIG. 4K provides an exemplary input screen in this regard. In step 3059, the CDSS service 240 retrieves the medical workers that satisfy the search criteria. In step 3060, data store 250 returns data satisfying the criteria to CDSS service 240. In step 3061, CDSS UI 260 displays medical workers satisfying the criteria in a list. FIG. 4L illustrates an exemplary interface in this regard. In step 3062, the user 200/220 can chose the medical worker to inherit a case. In step 3063, CDSS UI displays the reassignment summary. FIG. 4M illustrates an exemplary interface in this regard. In step 3064, the reassignment is confirmed by the user 200/220. In step 3065, the reassignment information is persisted. In step 3066, the case information is updated in the data store 250. In step 3067, the CDSS UI displays the reassignment confirmation. FIG. 4N illustrates an exemplary interface in this regard.

The CDSS service may also capture human behavior around accepting or rejecting the machine recommendations that allows for metrics (including, but not limited to, the following) being captured:

Overall Accuracy % across all recommendations

Accuracy categorized by Machine confidence ranges

Accuracy categorized by Procedures

Accuracy categorized by Medical policies and guidelines

Efficiency measured by number of cases handled/per day by the users

The information can be rendered visually in ways other than that provided in the examples shown herein. The exemplary implementation illustrated herein captures the elements that provide a comprehensive presentation of the decision suggestions and captures user behavior. This information can be made available on any rendering devices available, including but not limited to PCs, browser-based Mobile devices, and tablets etc.

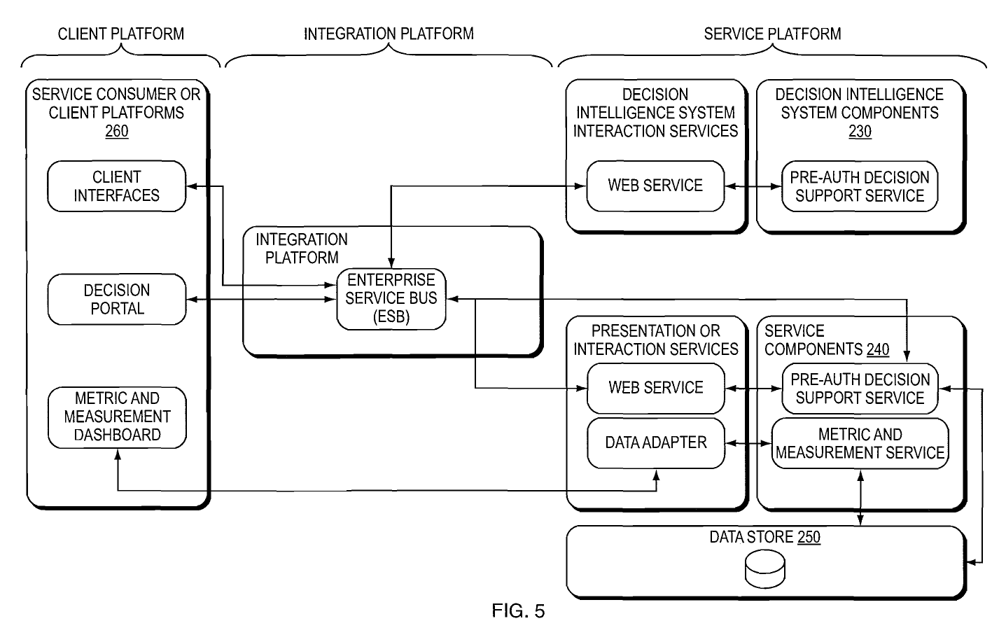

An exemplary system is now described with reference to FIG. 5. The system may comprise three platforms: a client platform, an integration platform, and a service platform. The client platform may include the client interfaces, the decision portal and the metric and measurement dashboard of CDSS UI 260. The integration platform may include an enterprise service bus. Service platform may include CDSS service 240, which may include interaction services and system components, and evidence based decision intelligence system 230, which may include interaction services and system components.

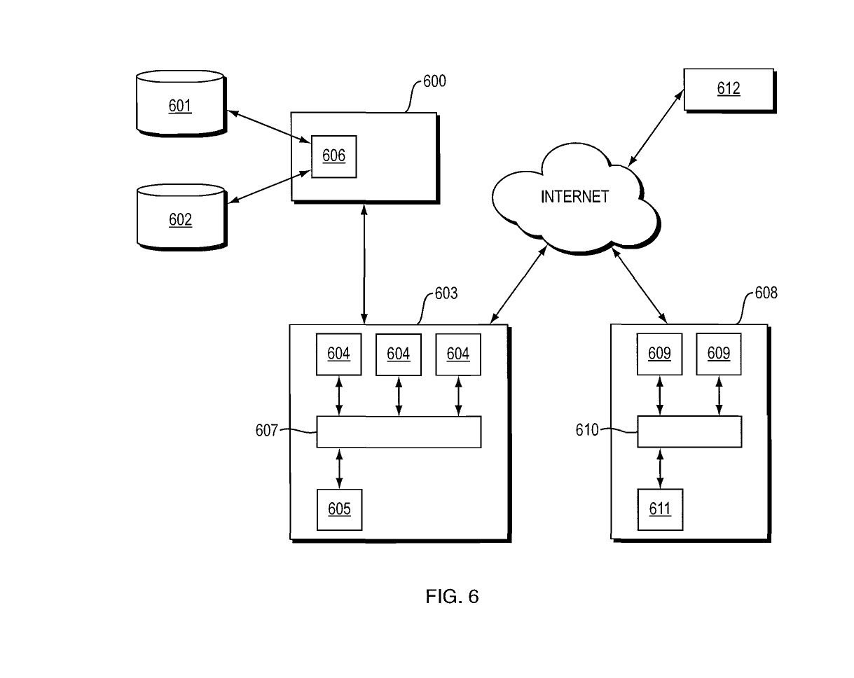

Exemplary hardware and software employed by the systems discussed herein are now generally described with reference to FIG. 6. Database server(s) 600 may include a database services management application 606 that manages storage and retrieval of data from the database(s) 601, 602. The databases may be relational databases; however, other data organizational structure may be used without departing from the scope of the present invention. One or more application server(s) 603 are in communication with the database server 600. The application server 603 communicates requests for data to the database server 600. The database server 600 retrieves the requested data. The application server 603 may also send data to the database server for storage in the database(s) 601, 602. The application server 603 comprises one or more processors 604, computer readable storage media 605 that store programs (computer readable instructions) for execution by the processor(s), and an interface 607 between the processor(s) 604 and computer readable storage media 605. The application server may store the computer programs referred to herein.

To the extent data and information is communicated over the Internet, one or more Internet servers 608 may be employed. The Internet server 608 also comprises one or more processors 609, computer readable storage media 611 that store programs (computer readable instructions) for execution by the processor(s) 609, and an interface 610 between the processor(s) 609 and computer readable storage media 611. The Internet server 608 is employed to deliver content that can be accessed through the communications network, e.g., by stakeholder 601 or knowledge worker 602. When data is requested through an application, such as an Internet browser, the Internet server 608 receives and processes the request. The Internet server 608 sends the data or application requested along with user interface instructions for displaying a user interface.

The computers referenced herein are specially programmed, in accordance with the described algorithms, to perform the functionality described herein.

The non-transitory computer readable storage media that store the programs (i.e., software modules comprising computer readable instructions) may include volatile and non-volatile, removable and non-removable media implemented in any method or technology for storage of information such as computer-readable instructions, data structures, program modules, or other data. Computer readable storage media may include, but is not limited to, RAM, ROM, Erasable Programmable ROM (EPROM), Electrically Erasable Programmable ROM (EEPROM), flash memory or other solid state memory technology, CD-ROM, digital versatile disks (DVD), or other optical storage, magnetic cassettes, magnetic tape, magnetic disk storage or other magnetic storage devices, or any other medium which can be used to store the desired information and which can be accessed by the computer system and processed.

The computer applications described herein may be hosted in a public, private or hybrid Internet cloud environment, in some embodiments.

What is claimed is:

1. A computer-implemented method comprising:
receiving a request for pre-authorization of a medical procedure for a medical condition;
receiving data describing the request for pre-authorization; and
receiving a recommendation regarding approval of the request for pre-authorization, the recommendation being generated by an evidence based decision intelligence system.

2. The method of claim 1 wherein the evidence based decision intelligence system generates the recommendation based on medical evidence related to the medical procedure.

3. The method of claim 2 further comprising:
receiving, in connection with the recommendation, data describing evidence in support of the recommendation.

4. The method of claim 1 wherein the evidence based decision intelligence system generates the recommendation based on policies and guidelines related to the medical procedure.

5. The method claim 4 further comprising:
receiving, in connection with the recommendation, data describing policies and guidelines associated with the recommendation.

6. The method of claim 1 further comprising:
receiving feedback regarding the recommendation from a medical worker.

7. The method of claim 1 wherein the data describing the request for pre-authorization comprises a case identifier associated with the medical condition, a data of service relating to the medical condition, a diagnostic code associated with the medical condition, and a procedure code associated with the medical procedure.

8. The method of claim 1, wherein the recommendation is incomplete, the method further comprising:
receiving from a medical worker a request to refer to the recommendation to a physician for review.

9. The method of claim 1, wherein the recommendation is incorrect, the method further comprising:
receiving from a medical worker a request to refer to the recommendation to a physician for review.

10. The method of claim 8, the method further comprising:
receiving from the physician an instruction to approve or deny the request for preauthorization.

11. The method of claim 9, the method further comprising:
receiving from the physician an instruction to approve or deny the request for preauthorization.

12. The method of claim 1, further comprising:
storing data describing a plurality of requests for pre-authorization;
receiving search criteria; and
retrieving data describing any of the plurality of requests for pre-authorization that meet the search criteria.

13. The method of claim 12 wherein the search criteria comprises an identifier of a previously assigned medical worker and wherein retrieved data comprises any requests for pre-authorization assigned to the previously assigned medical worker, the method further comprising:
reassigning the request for pre-authorization from the previously assigned medical worker to an alternate medical worker.

14. A non-transitory computer-readable storage medium that stores instructions which, when executed by one or more processors, cause the one or more processors to perform a method comprising:
receiving a request for pre-authorization of a medical procedure for a medical condition;
receiving data describing the request for pre-authorization; and
receiving a recommendation regarding approval of the request for pre-authorization, the recommendation being generated by an evidence based decision intelligence system.

15. The non-transitory computer-readable storage medium of claim 14 wherein the evidence based decision intelligence system generates the recommendation based on medical evidence related to the medical procedure.

16. The non-transitory computer-readable storage medium of claim 15, the method further comprising:
receiving, in connection with the recommendation, data describing evidence in support of the recommendation.

17. The non-transitory computer-readable storage medium of claim 14 wherein the evidence based decision intelligence system generates the recommendation based on policies and guidelines related to the medical procedure.

18. The non-transitory computer-readable storage medium of claim 17, the method further comprising:
receiving, in connection with the recommendation, data describing policies and guidelines associated with the recommendation.

19. The non-transitory computer-readable storage medium of claim 14, the method further comprising:
receiving feedback regarding the recommendation from a medical worker.

20. The non-transitory computer-readable storage medium of claim 14 wherein the data describing the request for pre-authorization comprises a case identifier associated with the medical condition, a data of service relating to the medical condition, a diagnostic code associated with the medical condition, and a procedure code associated with the medical procedure.

21. The non-transitory computer-readable storage medium of claim 14, wherein the recommendation is incomplete, the method further comprising:
receiving from a medical worker a request to refer to the recommendation to a physician for review.

22. The non-transitory computer-readable storage medium of claim 14, wherein the recommendation is incorrect, the method further comprising:
receiving from a medical worker a request to refer to the recommendation to a physician for review.

23. The non-transitory computer-readable storage medium of claim 21, the method further comprising:
receiving from the physician an instruction to approve or deny the request for preauthorization.

24. The non-transitory computer-readable storage medium of claim 22, the method further comprising:
receiving from the physician an instruction to approve or deny the request for preauthorization.

25. The non-transitory computer-readable storage medium of claim 14, the method further comprising:
storing data describing a plurality of requests for pre-authorization;
receiving search criteria; and
retrieving data describing any of the plurality of requests for pre-authorization that meet the search criteria.

26. The method of claim 25 wherein the search criteria comprises an identifier of a previously assigned medical worker and wherein retrieved data comprises any requests for pre-authorization assigned to the previously assigned medical worker, the method further comprising:
reassigning the request for pre-authorization from the previously assigned medical worker to an alternate medical worker.

27. A system comprising:
memory operable to store at least one program; and
at least one processor communicatively coupled to the memory, in which the at least one program, when executed by the at least one processor, causes the at least one processor to:
receive a request for pre-authorization of a medical procedure for a medical condition;
receive data describing the request for pre-authorization; and
receive a recommendation regarding approval of the request for pre-authorization, the recommendation being generated by an evidence based decision intelligence system.

28. The system of claim 27 wherein the evidence based decision intelligence system generates the recommendation based on medical evidence related to the medical procedure.

29. The system of claim 28, the processor further caused to:
receive, in connection with the recommendation, data describing evidence in support of the recommendation.

30. The system of claim 27 wherein the evidence based decision intelligence system generates the recommendation based on policies and guidelines related to the medical procedure.

31. The system of claim 30, the processor further caused to:
receive, in connection with the recommendation, data describing policies and guidelines associated with the recommendation.

32. The system of claim 27, the processor further caused to:
receive feedback regarding the recommendation from a medical worker.

33. The system of claim 27 wherein the data describing the request for pre-authorization comprises a case identifier associated with the medical condition, a data of service relating to the medical condition, a diagnostic code associated with the medical condition, and a procedure code associated with the medical procedure.

34. The system of claim 27, wherein the recommendation is incomplete, the processor further caused to:
receive from a medical worker a request to refer to the recommendation to a physician for review.

35. The system of claim 27, wherein the recommendation is incorrect, the processor further caused to:
receive from a medical worker a request to refer to the recommendation to a physician for review.

36. The system of claim 34, the processor further caused to:
receive from the physician an instruction to approve or deny the request for preauthorization.

37. The system of claim 35, the processor further caused to:
receive from the physician an instruction to approve or deny the request for preauthorization.

38. The system of claim 27, the processor further caused to:
store data describing a plurality of requests for pre-authorization;
receive search criteria; and
retrieve data describing any of the plurality of requests for pre-authorization that meet the search criteria.

39. The system of claim 38 wherein the search criteria comprises an identifier of a previously assigned medical worker and wherein retrieved data comprises any requests for pre-authorization assigned to the previously assigned medical worker, the processor further caused to:
reassign the request for pre-authorization from the previously assigned medical worker to an alternate medical worker.
